(19) United States
(12) Patent Application Publication
(10) Pub. No.: US 2013/0269351 A1
(43) Pub. Date: Oct. 17, 2013

(54) MICROMIXER ASSEMBLY OF A TURBINE SYSTEM AND METHOD OF ASSEMBLY

(71) Applicants: Zhaoli Hu, Greer, SC (US); Mark Lawrence Hunt, Simpsonville, SC (US); Chandrudu Srikanth Kottilingam, Simpsonville, SC (US); James Christopher Monaghan, Woodruff, SC (US); John Drake Vanselow, Taylors, SC (US)

(72) Inventors: Zhaoli Hu, Greer, SC (US); Mark Lawrence Hunt, Simpsonville, SC (US); Chandrudu Srikanth Kottilingam, Simpsonville, SC (US); James Christopher Monaghan, Woodruff, SC (US); John Drake Vanselow, Taylors, SC (US)

(73) Assignee: General Electric Company, Schenectady, NY (US)

(21) Appl. No.: 13/449,012

(22) Filed: Apr. 17, 2012

(51) Int. Cl. F02C 1/00; B23P 17/00

(52) U.S. Cl. 60/748; 29/888

(57) ABSTRACT

A micromixer assembly of a turbine system includes a plate having at least one aperture comprising a receiving diameter. Also included is at least one tube having an inlet and an outlet for receiving a flow and dispersing the flow to a combustor, wherein the at least one tube includes an inner diameter and an outer diameter, wherein the outer diameter is configured to fit within the receiving diameter of the at least one aperture, wherein the at least one tube is operably coupled at a location on the outer diameter to the receiving diameter of the at least one aperture by exerting a radial force on the inner diameter of the tube.

### BACKGROUND OF THE INVENTION

The subject matter disclosed herein relates to turbine systems, and more particularly to micromixer assemblies of turbine systems.

Turbine systems often include a micromixer assembly that typically includes a plurality of pipes or tubes that are disposed within apertures of a micromixer plate. The number of pipes or tubes is commonly well in excess of 10,000, and therefore assembly of the pipes or tubes within each micromixer plate aperture is cumbersome. A common method of assembling the pipes or tubes within the apertures involves a brazing process which relies on relatively expensive brazing filler, which may include gold and/or nickel. Such a process is both time consuming and expensive.

### BRIEF DESCRIPTION OF THE INVENTION

According to one aspect of the invention, a micromixer assembly of a turbine system includes a plate having at least one aperture comprising a receiving diameter. Also included is at least one tube having an inlet and an outlet for receiving a flow and dispersing the flow to a combustor, wherein the at least one tube includes an inner diameter and an outer diameter, wherein the outer diameter is configured to fit within the receiving diameter of the at least one aperture, wherein the at least one tube is operably coupled at a location on the outer diameter to the receiving diameter of the at least one aperture by exerting a radial force on the inner diameter of the tube.

According to another aspect of the invention, a micromixer assembly of a turbine system includes a plate having a plurality of apertures. Also included is a plurality of tubes, each having an inner diameter and an outer diameter, wherein the outer diameter is configured to fit within the plurality of apertures. Further included is an expander configured to be removably disposed within the inner diameter, wherein the plurality of tubes are fixedly connected to the plurality of apertures by expansion of the expander.

According to yet another aspect of the invention, a method of assembling a micromixer assembly of a turbine system is provided. The method includes inserting an expander having at least one expander head within an inner diameter of a tube. Also included is inserting the tube into a receiving aperture of a plate. Further included is exerting a radial force on the tube with the expander to form at least one operable connection between an outer diameter of the tube and the receiving aperture.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a turbine system having a micromixer assembly located in a head end;

FIG. 2 is a top, cross-sectional view of a tube disposed within an aperture of a plate and an expander disposed within the tube;

FIG. 3 is a flow diagram illustrating a method of assembling the micromixer assembly.

The detailed description explains embodiments of the invention, together with advantages and features, by way of example with reference to the drawings.

### DETAILED DESCRIPTION OF THE INVENTION

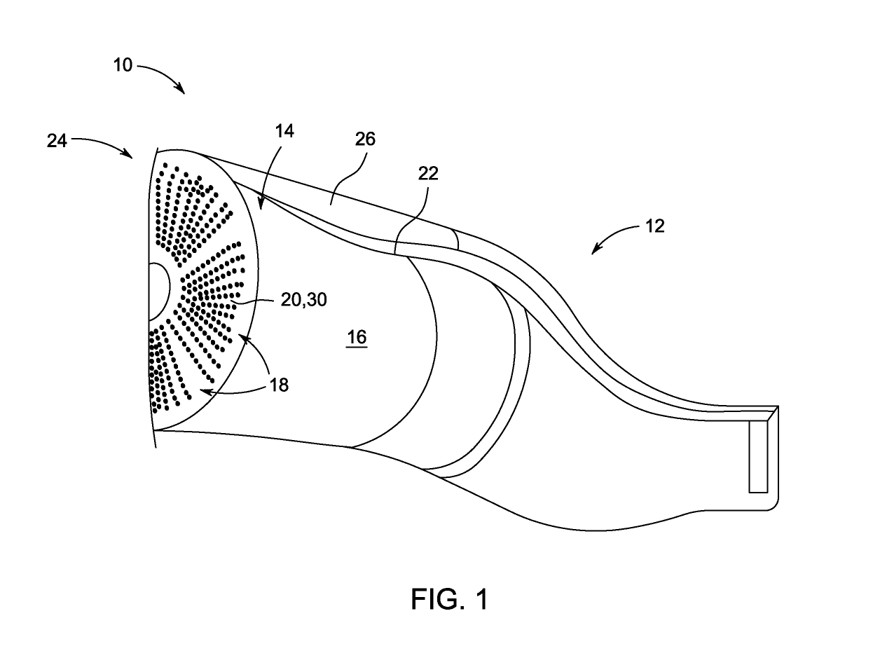

Referring to FIG. 1, illustrated is a turbine system 10 having a combustor section 12 and a head end 14. The head end 14 is disposed at an adjacent upstream location of the combustor section 12 and includes a micromixer assembly 16. The micromixer assembly 16 includes a plate 17 having a plurality of sectors 18 which each comprise a plurality of tubes 20. The combustor section 12 is defined by an outer liner 22 that extends to an upstream end 24. Spaced radially outwardly of the outer liner 22, and surroundingly enclosing the outer liner 22, is a flow sleeve 26. A flow of air passes upstream within an air passage defined by the outer liner 22 and the flow sleeve 26 to the upstream end 24 of the outer liner 22.

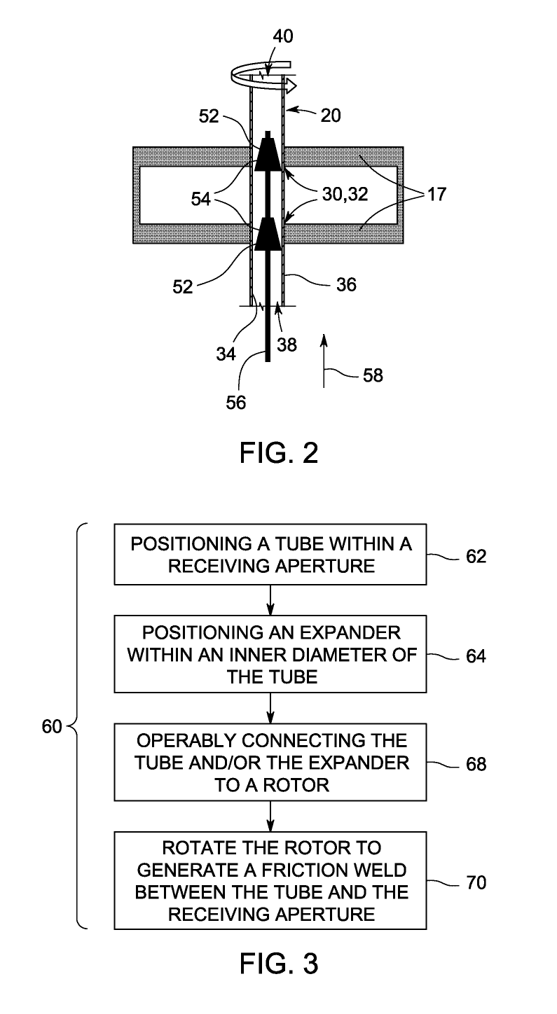

Referring to FIG. 2, a top, cross-sectional view of a tube 20 of the plurality of tubes is illustrated within a receiving aperture 30 of the plate 17. The plate 17 includes a plurality of receiving apertures that extend relatively axially through the plate 17 and are each configured to have a receiving diameter 32 that is dimensioned to allow the tube 20 to be inserted therein. Specifically, the tube 20 comprises an inner diameter 34, an outer diameter 36, an inlet 38 and an outlet 40. It is the outer diameter 36 of the tube 20 that is dimensioned to be inserted within the receiving diameter 32 of the receiving aperture 30. The tube 20 is typically formed of a durable material that is suitable for functioning in a region having a temperature that may exceed 1,600° F. (871° C.). Such a material may comprise stainless steel and/or a nickel-based alloy, such as Hastelloy® X. It is contemplated that a portion of a stainless steel tube may be formed of the Hastelloy® X material, such that only the non-stainless steel portion is disposed at the friction weld location, thereby providing a reliable portion of the tube 20 for enduring the aforementioned operation temperature. Similarly, the plate 17 comprises a material having high-temperature strength, such as stainless steel, for example. The aforementioned materials are discussed as merely illustrative examples and are not to be understood as limiting.

The inner diameter 34 of the tube 20 is dimensioned to receive an expander 50 that includes at least one expander head 52. Specifically, it is an outer diameter 54 of the expander head 52 that is to be closely dimensioned with that of the inner diameter 34 of the tube 20. The expander 50 comprises a shaft portion 56 that extends in a longitudinal direction 58 that relatively coincides with an axial direction of the turbine system 10, with the at least one expander head 52 disposed therealong. The function of the expander head 52 is to be controllably disposed at a position within the tube 20 that is desired to form a friction weld with the receiving aperture 30 of the plate 17, the method of which will be described in detail below. It is to be appreciated that more than one friction weld may be desired for each tube 20, and in such an application, the expander 50 includes a plurality of expander heads. This provides the ability to form a plurality of friction welds between each tube 20 and receiving aperture 30.

Referring to FIG. 3, a flow diagram generally illustrates a method of assembling 60 the micromixer assembly 16. The method of assembling 60 comprises positioning the tube within the receiving aperture 62 and positioning the expander within the inner diameter of the tube 64. The expander 50 is situated to have the expander head 52, or the expander heads in the case of a plurality of friction welds as described above, disposed at a desired friction weld location. A rotor is operably connected to the tube and/or the expander shaft portion 68. The rotor is then rotated 70 and 50 to a predetermined speed that is sufficient to result in a generation of heat through mechanical friction between the outer diameter 36 of the tube 20 and the stationary receiving aperture 30 of the plate 17. The expander 50, and particularly the expander head 52, provides a radial force, known as an upset force, to displace and fuse the tube 20 to the receiving aperture 30.

It is to be appreciated that the expander 50 and the tube 20 may be rotated at speeds distinct from one another during the method of assembling 60. This may be accomplished by employing a gear system, such as a planetary gear, where various gear ratios may be achieved by manipulation of the input gear of the planetary gear. In such an arrangement, the tube 20 may rotate at a first speed, which is different than that of a second speed that the expander 50 may rotate at. The precise speeds used will vary depending on the specific application, but as an example, the first speed may be about 1,000 rpm, while the second speed may be about 950 rpm. It is to be understood that the illustrative speeds described above are not limiting and that the ratio and speeds will vary accordingly. Operation at suitable speeds provide a relative rotational speed for the expander 50, with respect to that of the tube 20 to generate an expanding effect, while avoiding excessive internal wall friction heat, which possibly leads to jointing the inner diameter 34 of the tube 20 to the expander 50. Subsequent to the formation of the friction weld between the tube 20 and the receiving aperture 30, the expander 50 is removed from the inner diameter 34 of the tube 20. During the method of assembling 60, the expander 50 and inner diameter 34 of the tube 20 are lubricated and liquid cooled. It is to be understood that the above description for the method of assembling 60 is not intended to limit the precise order of operations, such that the method of assembling 60 may include a different order of operations based on numerous assembly factors.

Advantageously, the method of assembly 60 provides the capability to form each friction weld in a matter of seconds, thereby significantly reducing the time required to mechanically join the tube 20 and the receiving aperture 30 of the plate 17, when compared to other processes employed to form such a mechanical joint, such as brazing, for example. Additionally, the method of assembling 60 employs direct heat input at the friction weld interface, yielding relatively small heat-affected zones. Such benefits are particularly useful in a high temperature operation region, such as that of the micromixer assembly 16. The friction welding process also requires relatively brief preparation time, based on the tendency of the mechanical friction between the tube 20 and the receiving aperture 30 tending to clean the surface between the materials being welded. This is typically achieved when the aforementioned flash carries away dirt and debris that may have been present on a surface of the tube 20 and/or receiving aperture 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A micromixer assembly of a turbine system comprising:
a plate having at least one aperture comprising a receiving diameter;
at least one tube having an inlet and an outlet for receiving a flow and dispersing the flow to a combustor, wherein the at least one tube includes an inner diameter and an outer diameter, wherein the outer diameter is configured to fit within the receiving diameter of the at least one aperture; and
wherein the at least one tube is operably coupled at a location on the outer diameter to the receiving diameter of the at least one aperture by exerting a radial force on the inner diameter of the tube.

2. The micromixer assembly of claim 1, further comprising an expander configured to be received within the inner diameter of the at least one tube, wherein the expander includes at least one expander head.

3. The micromixer assembly of claim 2, wherein the at least one expander head is configured to expand upon rotation of the expander at a predetermined speed.

4. The micromixer assembly of claim 3, wherein the at least one expander head generates the radial force on the inner diameter of the at least one tube upon rotation of the expander at the predetermined speed.

5. The micromixer assembly of claim 4, wherein the at least one tube is friction welded to the at least one aperture.

6. The micromixer assembly of claim 1, wherein the at least one tube comprises stainless steel.

7. The micromixer assembly of claim 1, wherein the at least one tube comprises a nickel-based alloy.

8. The micromixer assembly of claim 1, wherein the plate comprises stainless steel.

9. The micromixer assembly of claim 1, further comprising a plurality of apertures and a plurality of tubes.

10. A micromixer assembly of a turbine system comprising:
a plate having a plurality of apertures;
a plurality of tubes, each having an inner diameter and an outer diameter, wherein the outer diameter is configured to fit within the plurality of apertures; and
an expander configured to be removably disposed within the inner diameter, wherein the plurality of tubes are fixedly connected to the plurality of apertures by expansion of the expander.

11. The micromixer assembly of claim 10, further comprising an expander head of the expander, wherein the expander head expands upon rotation of the expander at a predetermined speed.

12. The micromixer assembly of claim 11, wherein the plurality of tubes are friction welded to the plurality of apertures upon expansion of the expander.

13. A method of assembling a micromixer assembly of a turbine system comprising:
inserting an expander having at least one expander head within an inner diameter of a tube;
inserting the tube into a receiving aperture of a plate; and
exerting a radial force on the tube with the expander to form at least one operable connection between an outer diameter of the tube and the receiving aperture.

14. The method of claim 13, further comprising friction welding the outer diameter of the tube to the receiving aperture.

15. The method of claim 13, further comprising operably coupling a rotor to the tube.

16. The method of claim 15, further comprising operably coupling the rotor to the expander.

17. The method of claim 16, further comprising rotating the tube at a first rotational speed and rotating the expander at a second rotational speed.

18. The method of claim 13, wherein the tube comprises stainless steel.

19. The method of claim 13, wherein the tube comprises a nickel-based alloy.

20. The method of claim 13, further comprising lubricating and liquid cooling the expander and the inner diameter of the tube.
